(19) United States
(12) Patent Application Publication
(10) Pub. No.: US 2023/0076534 A1
(43) Pub. Date: Mar. 9, 2023

(54) IMAGE PROCESSING METHOD AND DEVICE, CAMERA COMPONENT, ELECTRONIC DEVICE AND STORAGE MEDIUM

(71) Applicants: BeijingXiaomi Mobile Software Co., Ltd., Nanjing Branch, Nanjing, Jiangsu (CN); Beijing Xiaomi Mobile Software Co., Ltd., Beijing (CN)

(72) Inventors: Jing XU, Beijing (CN); Lin LIU, Beijing (CN); Dan ZHU, Beijing (CN)

(21) Appl. No.: 17/274,044

(22) PCT Filed: May 27, 2020
(86) PCT No.: PCT/CN2020/092507

§ 371 Date: Mar. 5, 2021

(51) Int. Cl. H04N 5/225; H04N 5/232; G06T 5/50

(52) U.S. Cl. CPC H04N 5/2258; H04N 5/2256; H04N 5/23296; G06T 5/50; G06T 2207/20221; G06T 2207/10028; G06T 2207/10048; H04N 9/04553

(57) ABSTRACT

The present disclosure relates to an image processing method and device, a camera component, an electronic device, and a storage medium. The component includes a first camera module sensing first-band light to generate a first image, a second camera module sensing the first-band light and second-band light and generating a second image, an infrared light source emitting the second-band light and a processor. The second image includes a bayer subimage and an infrared subimage. The processor is coupled with the first camera module, the second camera module and the infrared light source respectively. The processor is configured to perform image processing on at least one of the bayer subimage or the infrared subimage and the first image. In the embodiments, a depth image may be acquired without arranging any depth camera in a camera module array, so that the size of the camera component may be reduced, a space occupied by the component in an electronic device may be reduced, and miniaturization and cost reduction of the electronic device are facilitated.

### TECHNICAL FIELD

The present disclosure relates to the technical field of image processing, and more particularly, to an image processing method and device, a camera component, an electronic device, and a storage medium.

### BACKGROUND

A conventional camera may be configured to record a video or take a picture, collect brightness information and color information of a scenario, but cannot collect depth information. Along with increase of application requirements, depth cameras have been added to cameras of some electronic devices to form camera arrays at present. The depth camera may include an array camera module, a structured light module and a time of flight (TOF) module, and depth information may be obtained according to a working principle of each module. However, the camera array requires independent arrangement of the depth camera, which results in occupation of a valuable space of the electronic device and is unfavorable for miniaturization and cost reduction of the electronic device.

### SUMMARY

In view of this, the present disclosure provides an image processing method and device, a camera component, an electronic device, and a storage medium.

According to a first aspect of embodiments of the present disclosure, a camera component is provided, which may include: a first camera module sensing first-band light, a second camera module sensing the first-band light and second-band light, an infrared light source emitting the second-band light, and a processor. The processor may be coupled with the first camera module, the second camera module and the infrared light source respectively. The first camera module may be configured to generate a first image under control of the processor; the infrared light source may be configured to emit the second-band light under the control of the processor; the second camera module may be configured to generate a second image under the control of the processor, and the second image may include a bayer subimage generated by sensing the first-band light and an infrared subimage generated by sensing the second-band light. The processor may further be configured to perform image processing on at least one of the bayer subimage or the infrared subimage and the first image.

Optionally, the infrared light source may include at least one of: an infrared flood light source, a structured light source or a TOF light source.

Optionally, fields of view of camera lenses in the first camera module and the second camera module may be different.

According to a second aspect of embodiments of the present disclosure, an image processing method is provided, which may include: a first image generated by a first camera module and a second image generated by a second camera module are acquired, the second image including a bayer subimage generated by the second camera module by sensing first-band light and an infrared subimage generated by sensing second-band light; and image processing is performed on at least one of the bayer subimage or the infrared subimage and the first image.

Optionally, the operation that the image processing is performed on at least one of the bayer subimage or the infrared subimage and the first image may include: the infrared subimage and the first image are fused to enhance the first image.

Optionally, the operation that the image processing is performed on at least one of the bayer subimage or the infrared subimage and the first image may include: a visible light depth image is acquired according to the bayer subimage and the first image.

Optionally, when an infrared light source includes a structured light source or a TOF light source, the operation that the image processing is performed on at least one of the bayer subimage or the infrared subimage and the first image may include: the visible light depth image and depth data of the infrared subimage are fused to obtain a depth fused image.

Optionally, the method may further include: responsive to a zooming operation of a user, image zooming is performed based on the first image and the bayer subimage.

According to a third aspect of embodiments of the present disclosure, an image processing device is provided, which may include: an image acquisition module, configured to acquire a first image generated by a first camera module and a second image generated by a second camera module, the second image including a bayer subimage generated by the second camera module by sensing first-band light and an infrared subimage generated by sensing second-band light; and an image processing module, configured to perform image processing on at least one of the bayer subimage or the infrared subimage and the first image.

Optionally, the image processing module may include: an image enhancement unit, configured to fuse the infrared subimage and the first image to enhance the first image.

Optionally, the image processing module may include: a depth image acquisition unit, configured to acquire a visible light depth image according to the bayer subimage and the first image.

Optionally, when an infrared light source includes a structured light source or a TOF light source, the image processing module may include: a depth fusion unit, configured to fuse the visible light depth image and depth data of the infrared subimage to obtain a depth fused image.

Optionally, the device may further include: a zooming module, configured to, responsive to a zooming operation of a user, perform image zooming based on the first image and the bayer subimage.

According to a fourth aspect of embodiments of the present disclosure, an electronic device is provided, which may include: the abovementioned camera component; a processor; and a memory configured to store a computer program executable by the processor. The processor may be configured to execute the computer program in the memory to implement the steps of any abovementioned method.

According to a fifth aspect of embodiments of the present disclosure, a readable storage medium is provided, in which an executable computer program may be stored, the computer program is executed to implement the steps of any abovementioned method.

The technical solutions provided in the embodiments of the present disclosure may have the following beneficial effects.

It can be seen from the embodiments that, in the embodiments of the present disclosure, the first camera module in the camera component may collect the first image, the second camera module acquires the second image, the bayer subimage and the infrared subimage may be acquired from the second image, and then image processing, for example, acquisition of the depth image, may be performed on at least one of the bayer subimage or the infrared subimage and the first image, that is, the depth image may be acquired without arranging any depth camera in a camera module array, such that the size of the camera component may be reduced, a space occupied by it in the electronic device may be reduced, and miniaturization and cost reduction of the electronic device are facilitated.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a block diagram of a camera component, according to an exemplary embodiment.

FIG. 2 is a diagram of an application scenario, according to an exemplary embodiment.

FIG. 3 is a schematic diagram illustrating acquisition of a visible light depth image, according to an exemplary embodiment.

FIG. 4 is a flow chart showing a depth data acquisition method, according to an exemplary embodiment.

FIG. 5 is a block diagram of a depth data acquisition device, according to an exemplary embodiment.

FIG. 6 is a block diagram of an electronic device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The embodiments set forth in the following exemplary description do not represent all embodiments consistent with the present disclosure. Instead, they are merely examples of apparatuses consistent with aspects related to the present disclosure as recited in the appended claims.

A conventional camera may be configured to record a video or take a picture, collect brightness information and color information of a scenario, but cannot collect depth information. Along with increase of application requirements, depth cameras have been added to cameras of some electronic devices to form camera arrays at present. The depth camera may include an array camera module, a structured light module and a TOF module, and depth information may be obtained according to a working principle of each module. However, the camera array requires independent arrangement of the depth camera, which results in occupation of a valuable space of the electronic device and is unfavorable for miniaturization and cost reduction of the electronic device.

To solve the above technical problem, embodiments of the present disclosure provide an image processing method and device, a camera component, an electronic device, and a storage medium. The inventive concept is that: a first camera module configured to sense first-band light and acquire a first image and a second camera module configured to sense the first-band light and second-band light and acquire a second image are arranged in a camera module array, and a processor may perform image processing, for example, acquisition of a depth image, on at least one of a bayer subimage or an infrared subimage in the second image and the first image.

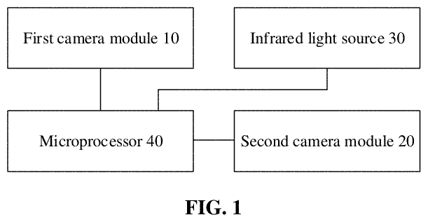

FIG. 1 is a block diagram of a camera component, according to an exemplary embodiment. Referring to FIG. 1, the camera component may include a first camera module 10, a second camera module 20, an infrared light source 30 and a processor 40. The first camera module 10 may sense first-band light, and the second camera module 20 may sense the first-band light and second-band light. The processor 40 is coupled with the first camera module 10, the second camera module 20 and the infrared light source 30 respectively. The term being coupled with refers to that the processor 40 may send a control instruction and acquire images from the camera modules 10, 20, and may specifically be implemented through a communication bus, a cache or a wireless manner. No limits are made herein.

The first camera module 10 is configured to generate a first image under the control of the processor 40. The first image may be a red green blue (RGB) image.

The infrared light source 30 is configured to emit the second-band light under the control of the processor 40.

The second camera module 20 is configured to generate a second image under the control of the processor 40. The second image may include a bayer subimage generated by sensing the first-band light and an infrared subimage generated by sensing the second-band light.

The processor 40 is configured to acquire the bayer subimage and the infrared subimage according to the second image, and perform image processing on at least one of the bayer subimage or the infrared subimage and the first image.

Exemplarily, in the embodiments, the first-band light may be light of a visible light band, and the second-band light may be light of an infrared band.

In the embodiments, the first camera module 10 may include an image sensor, a camera lens, an infrared filter and other elements responding to the first-band light (for example, the visible light band), and may further include a voice coil motor, a circuit substrate and other elements. The image sensor may respond to the first-band light by use of a charge-coupled device (CCD), a complementary metal oxide semiconductor (CMOS), or the like. For facilitating cooperative use of the first camera module 10 and the second camera module 20, a filter in the image sensor of the first camera module 10 may be a color filter array only responding to the visible light band such as a bayer template, a cyan yellow yellow magenta (CYYM) template, a cyan yellow green magenta (CYGM) template, and the like. A mounting position and working principle of each element of the first camera module 10 may refer to a related art and will not be repeated herein.

In the embodiments, the second camera module 20 may include an image sensor, a camera lens, a visible light-near infrared bandpass filter and other elements responding to both the first-band light (for example, light of the visible light band) and the second-band light (for example, light of the infrared band), and may further include a voice coil motor, a circuit substrate and other elements. The image sensor responding to both the first-band light and the second-band light may be implemented by use of the CCD, the CMOS, or the like, and a filter thereof may be a color filter array responding to both the visible light band and the infrared band such as an RGB infrared (RGBIR) template, an RGB white (RGBW) template, and the like. A mounting position and working principle of each element of the second camera module 20 may refer to the related art and will not be repeated herein.

In the embodiments, the infrared light source 30 may include at least one of an infrared flood light source, a structured light source or a TOF light source. A working principle of the infrared flood light source is to increase infrared illuminating brightness to an object in a framing range. A working principle of the structured light source is to project specific light information to a surface of the object and a background and calculate information of a position, depth and the like of the object according to a change of a light signal caused by the object. A working principle of the TOF light source is to project an infrared pulse into the framing range and calculate a distance of the object according to round-trip time of the infrared pulse.

In the embodiments, the processor 40 may be implemented by an independently arranged microprocessor, and may also be implemented by a processor of an electronic device with the camera component. The processor 40 has functions of the following two aspects.

In a first aspect, an operation signal of one or combination of a button, a microphone (MIC) and the image sensor may be received to control the first camera module 10, the second camera module 20 and the infrared light source 30. For example, when the electronic device is in a normal photographic mode, the processor 40 may adjust a parameter of the first camera module 10, such as a focal length, brightness, and the like. When detecting a shutter pressing action of a user, the processor 40 may control the first camera module 10 to take a picture. When the electronic device is in a panorama, high-dynamic range (HDR), entire focus or other mode or in a low-light scenario, the processor 40 may turn on/activate the infrared light source 30, simultaneously adjust parameters of the first camera module 10 and the second camera module 20, such as focal lengths, brightness and the like. When detecting the shutter pressing action of the user, the processor 40 may control the first camera module 10 to take a picture to obtain the first image and control the second camera module 20 to take a picture to obtain the second image.

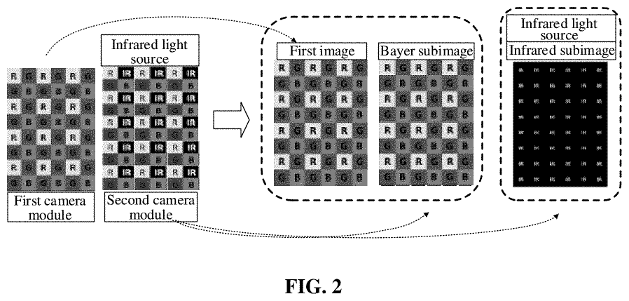

In a second aspect, when a depth image is required, as illustrated in FIG. 2, the electronic device may process the first image and the second image to acquire a visible light depth image or a depth fused image.

In an example, the processor may extract the bayer subimage corresponding to the first-band light from the second image, and calculate the visible light depth image according to the first image and the bayer subimage. The calculating process is as follows.

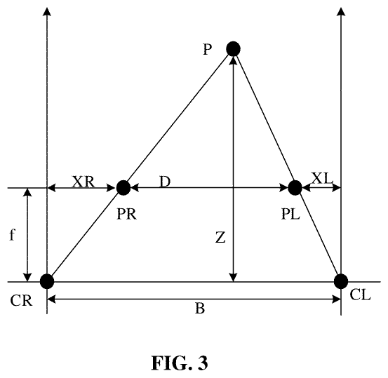

Referring to FIG. 3, P is a certain point of an object to be detected (i.e., a shooting target) in a framing range, CR and CL are optical centers of a first camera and a second camera respectively, imaging points of the point P on light sensors of the two cameras are PR and PL respectively (image planes of the cameras are positioned in front of the camera lenses after rotation), f is a focal length of the camera, B is a center distance of the two cameras, and Z is a depth to be detected. If a distance between the point PR and the point PL is set to be D:

D=B−(XR−XL).

According to a principle of similar triangles:

[B−(XR−XL)]/B=(Z−F)/Z,

it may be obtained that:

Z=fB/(XR−XL).

The focal length f, the center distance B of the cameras, a coordinate XR of the point P on the right image plane and a coordinate XL of the point P on the left image plane may be obtained by calibration, therefore it is necessary to obtain (XR−XL) to obtain the depth, where f, B, XR and XL may be determined by calibration, correction and matching operations. The calibration, correction and matching operations may refer to the related art and will not be repeated herein.

The processor 40 may repeat the abovementioned steps to obtain depths of all pixels in the first image to obtain the visible light depth image. The visible light depth image may be configured for service scenarios including a large aperture, face/iris unlocking, face/iris payment, three-dimensional (3D) retouching, studio lighting, Animoji, and the like.

In an example, fields of view of each camera in the first camera module 10 and the second camera module 20 may be different, and a magnitude relationship of them is not limited. In such case, the processor 40 may crop images in corresponding sizes from the first image and the second image in combination with the fields of view of the two cameras. For example, a frame of image in a relatively large size is cropped from the bayer subimage extracted from the second image, and then a frame of image in a relatively small size is cropped from the first image, that is, the image cropped from the bayer subimage of the second image is larger than the image cropped from the first image. Then, the images are sequentially displayed. Therefore, a zooming effect may be achieved, that is, a shooting effect like optical zooming may be achieved in the embodiments, which is favorable for improving a shooting experience.

In another example, considering that the second image further includes infrared information, the processor 40 may extract the infrared subimage generated by sensing the second-band light from the second image. Since high-frequency information in a frequency domain of the infrared subimage is richer than information in a frequency domain of the first image, the infrared subimage and the first image may be fused, for example, the high-frequency information of the infrared subimage is extracted and added to the frequency domain of the first image, to achieve an effect of enhancing the first image and ensure that the fused first image has richer details and is higher in resolution and more accurate in color. In addition, the infrared subimage may further be configured for a biometric recognition function of the electronic device, for example, fingerprint unlocking, face recognition and other scenarios.

In another example, considering that the infrared light source may be the structured light source, still referring to FIG. 2, under the condition that the infrared light source includes the structured light source, the processor 40 may further acquire infrared depth data based on the infrared subimage. For example, the processor 40 may control the infrared light source 30 to project a light beam of a specific direction to a shooting target such as an object or a background, and acquire a parameter of an echo signal of the light beam, such as strength, a spot size or the like. The processor 40 may obtain infrared depth data from the shooting target to the camera based on a preset corresponding relationship between a parameter and a distance, and the infrared depth data is relative to the visible light depth image and may include texture information of the shooting target such as the object or the background. In such case, the processor 40 may select to use the visible light depth image or the infrared depth data according to a specific scenario. For example, the visible light depth image may be used in a high-light scenario (that is, an ambient brightness value is greater than a preset brightness value, like a daytime scenario), in a scenario that the shooting target is semitransparent or in a scenario that the shooting target absorbs infrared light. For example, the infrared depth data may be used in a low-light scenario (that is, the ambient brightness value is greater than the preset brightness value, like a night scenario), in a scenario that the shooting target is a texture-less object or in a scenario that the shooting target is an object that periodically appears. The visible light depth image or the infrared depth data may also be fused to obtain the depth fused image. The depth fused image may compensate various defects of the visible light depth image and the infrared depth data, may be applied to almost all scenarios, particularly to scenarios of a poor illumination condition, the texture-less object, the periodically appearing object or the like, and is favorable for improving the confidence of the depth data.

In another example, considering that the infrared light source may be the TOF light source, still referring to FIG. 2, under the condition that the infrared light source includes the TOF light source, the processor 40 may further acquire the infrared depth data based on the infrared subimage, and the infrared depth data is relative to the visible light depth image and may include the texture information of the shooting target such as the object or the background. For example, the processor 40 may control the TOF light source to project a light beam of a specific direction to the object or the background, acquire a time difference between emission time and return time of an echo signal of the light beam, and calculate the infrared depth data from the object to the camera. In such case, the processor 40 may select to use the visible light depth image or the infrared depth data according to a specific scenario. For example, the visible light depth image may be used in a high-light scenario (that is, an ambient brightness value is greater than a preset brightness value, like a daytime scenario), in a scenario that the shooting target is semitransparent or in a scenario that the shooting target absorbs infrared light. For example, the infrared depth data may be used in a low-light scenario (that is, the ambient brightness value is greater than the preset brightness value, like a night scenario), in a scenario that the shooting target is a texture-less object or in a scenario that the shooting target is an object that periodically appears. The visible light depth image or the infrared depth data may also be fused to obtain the depth fused image. The depth fused image may compensate defects of the visible light depth image and the infrared depth data, may be applied to almost all scenarios, particularly to scenarios that an illumination condition is poor, the shooting target is the texture-less object, the periodically appearing object or the like, and is favorable for improving the confidence of the depth data.

It is to be noted that, in the embodiments, the structured light source or the TOF light source is selected, and improvement or addition of camera modules is not involved, such that difficulties in design may be greatly reduced.

Herein, in the embodiments of the present disclosure, the first camera module in the camera component may collect the first image, the second camera module acquires the second image, the bayer subimage and the infrared subimage may be acquired from the second image, and then image processing, for example, acquisition of the depth image, may be performed on at least one of the bayer subimage or the infrared subimage and the first image, that is, the depth image may be acquired without arranging any depth camera in a camera module array, such that the size of the camera component may be reduced, a space occupied by it in the electronic device may be reduced, and miniaturization and cost reduction of the electronic device are facilitated.

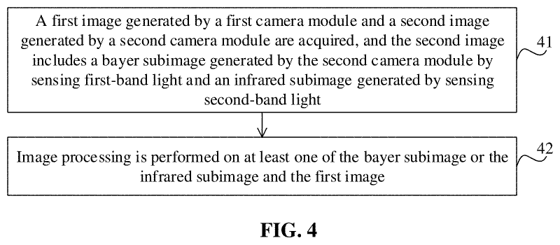

The embodiments of the present disclosure also provide an image processing method. FIG. 4 is a flow chart showing an image processing method, according to an exemplary embodiment. Referring to FIG. 4, the image processing method is applied to the camera component provided in the abovementioned embodiments and may include the following steps.

In step 41, a first image generated by a first camera module and a second image generated by a second camera module are acquired, and the second image includes a bayer subimage generated by the second camera module by sensing first-band light and an infrared subimage generated by sensing second-band light.

In step 42, image processing is performed on at least one of the bayer subimage or the infrared subimage and the first image.

In an embodiment, the operation in step 42 that the image processing is performed on at least one of the bayer subimage or the infrared subimage and the first image may include: the infrared subimage and the first image are fused to enhance the first image.

In an embodiment, the operation in step 42 that the image processing is performed on at least one of the bayer subimage or the infrared subimage and the first image may include: a visible light depth image is acquired according to the bayer subimage and the first image.

In an embodiment, when an infrared light source includes a structured light source or a TOF light source, the operation in step 42 that the image processing is performed on at least one of the bayer subimage or the infrared subimage and the first image may include: the visible light depth image and depth data of the infrared subimage are fused to obtain a depth fused image.

In an embodiment, the method may further include: responsive to a zooming operation of a user, image zooming is performed based on the first image and the bayer subimage.

It can be understood that the method provided in each embodiment of the present disclosure is matched with a working process of the camera component and specific contents may refer to the contents of each embodiment of the camera component and will not be repeated herein.

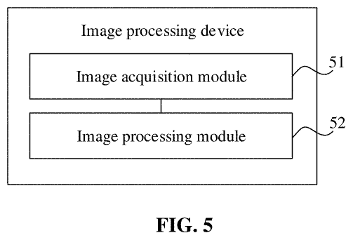

The embodiments of the present disclosure also provide an image processing device, referring to FIG. 5, which may include: an image acquisition module 51 and an image processing module 52.

The image acquisition module 51 is configured to acquire a first image generated by a first camera module and a second image generated by a second camera module, and the second image includes a bayer subimage generated by the second camera module by sensing first-band light and an infrared subimage generated by sensing second-band light.

The image processing module 52 is configured to perform image processing on at least one of the bayer subimage or the infrared subimage and the first image.

In an embodiment, the image processing module 52 may include: an image enhancement unit, configured to fuse the infrared subimage and the first image to enhance the first image.

In an embodiment, the image processing module 52 may include: a depth image acquisition unit, configured to acquire a visible light depth image according to the bayer subimage and the first image.

In an embodiment, when an infrared light source includes a structured light source or a TOF light source, the image processing module includes: a depth fusion unit, configured to fuse the visible light depth image and depth data of the infrared subimage to obtain a depth fused image.

In an embodiment, the device may further include: a zooming module, configured to, responsive to a zooming operation of a user, perform image zooming based on the first image and the bayer subimage.

It can be understood that the device provided in each embodiment of the present disclosure corresponds to the method embodiments and specific contents may refer to the contents of each method embodiment and will not be repeated herein.

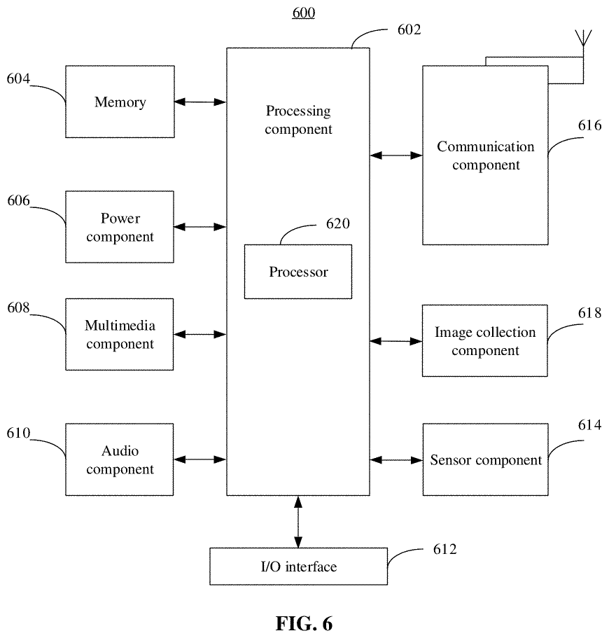

FIG. 6 is a block diagram of an electronic device, according to an exemplary embodiment. For example, the electronic device 600 may be a smart phone, a computer, a digital broadcast terminal, a tablet, a medical device, exercise equipment, a personal digital assistant, and the like.

Referring to FIG. 6, the electronic device 600 may include one or more of the following components: a processing component 602, a memory 604, a power component 606, a multimedia component 608, an audio component 610, an input/output (I/O) interface 612, a sensor component 614, a communication component 616 and an image collection component 618.

The processing component 602 typically controls overall operations of the electronic device 600, such as the operations associated with display, telephone calls, data communications, camera operations, and recording operations. The processing component 602 may include one or more processors 620 to execute computer programs. Moreover, the processing component 602 may include one or more modules which facilitate interaction between the processing component 602 and other components. For instance, the processing component 602 may include a multimedia module to facilitate interaction between the multimedia component 608 and the processing component 602.

The memory 604 is configured to store various types of data to support the operation of the electronic device 600. Examples of such data include computer programs for any applications or methods operated on the electronic device 600, contact data, phonebook data, messages, pictures, video, etc. The memory 604 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, and a magnetic or optical disk.

The power component 606 provides power for various components of the electronic device 600. The power component 606 may include a power management system, one or more power supplies, and other components associated with generation, management and distribution of power for the electronic device 600. The power component 606 may include a power chip, and a controller may communicate with the power chip, thereby controlling the power chip to turn on or turn off a switching device to cause or disable a battery to supply power to a mainboard circuit.

The multimedia component 608 includes a screen providing an output interface between the electronic device 600 and a target object. In some embodiments, the screen may include a liquid crystal display (LCD) and a touch panel (TP). If the screen includes the TP, the screen may be implemented as a touch screen to receive an input signal from the target object. The TP includes one or more touch sensors to sense touches, swipes and gestures on the TP. The touch sensors may not only sense a boundary of a touch or swipe action, but also detect a period of time and a pressure associated with the touch or swipe action.

The audio component 610 is configured to output and/or input an audio signal. For example, the audio component 610 includes a MIC, and the MIC is configured to receive an external audio signal when the electronic device 600 is in an operation mode, such as a call mode, a recording mode and a voice recognition mode. The received audio signal may further be stored in the memory 604 or sent through the communication component 616. In some embodiments, the audio component 610 further includes a speaker configured to output the audio signal.

The I/O interface 612 provides an interface between the processing component 602 and peripheral interface modules, such as a keyboard, a click wheel, buttons, and the like.

The sensor component 614 includes one or more sensors configured to provide status assessments in various aspects for the electronic device 600. For instance, the sensor component 614 may detect an on/off status of the electronic device 600 and relative positioning of components, such as a display screen and small keyboard of the electronic device 600, and the sensor component 614 may further detect a change in a position of the electronic device 600 or a component, presence or absence of contact between the target object and the electronic device 600, orientation or acceleration/deceleration of the electronic device 600 and a change in temperature of the electronic device 600.

The communication component 616 is configured to facilitate wired or wireless communication between the electronic device 600 and other devices. The electronic device 600 may access a communication-standard-based wireless network, such as a wireless fidelity (WiFi) network, a 2nd-generation (2G) or 3rd-generation (3G) network or a combination thereof. In an exemplary embodiment, the communication component 616 receives a broadcast signal or broadcast associated information from an external broadcast management system through a broadcast channel In an exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wide band (UWB) technology, a Bluetooth (BT) technology, and other technologies.

The image collection component 618 is configured to collect images. For example, the image collection component 618 may be implemented by the camera component provided in the abovementioned embodiments.

In an exemplary embodiment, the electronic device 600 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic components.

In an exemplary embodiment, there is also provided a non-transitory readable storage medium including an executable computer program, such as the memory 604 including instructions, and the executable computer program may be executed by the processor. The readable storage medium may be a ROM, a random access memory (RAM), a compact disc read-only memory (CD-ROM), a magnetic tape, a floppy disc, an optical data storage device, and the like.

Other implementation solutions of the present disclosure will be apparent to those skilled in the art from consideration of the specification and practice of the present disclosure. This present disclosure is intended to cover any variations, uses, or adaptations following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A camera component, comprising:
a first camera module sensing first-band light, a second camera module sensing the first-band light and second-band light, an infrared light source emitting the second-band light, and a processor; wherein:
the processor is coupled with the first camera module, the second camera module and the infrared light source respectively;
the first camera module is configured to generate a first image under control of the processor;
the infrared light source is configured to emit the second-band light under the control of the processor;
the second camera module is configured to generate a second image under the control of the processor, the second image comprising a bayer subimage generated by sensing the first-band light and an infrared subimage generated by sensing the second-band light; and
the processor is further configured to perform image processing on at least one of the bayer subimage or the infrared subimage and the first image.

2. The camera component of claim 1, wherein the infrared light source comprises at least one of: an infrared flood light source, a structured light source or a time of flight (TOF) light source.

3. The camera component of claim 1, wherein fields of view of camera lenses in the first camera module and the second camera module are different.

4. An image processing method, comprising:
acquiring a first image generated by a first camera module and a second image generated by a second camera module, the second image comprising a bayer subimage generated by the second camera module by sensing first-band light and an infrared subimage generated by sensing second-band light; and
performing image processing on at least one of the bayer subimage or the infrared subimage and the first image.

5. The image processing method of claim 4, wherein performing the image processing on at least one of the bayer subimage or the infrared subimage and the first image comprises:
fusing the infrared subimage and the first image to enhance the first image.

6. The image processing method of claim 4, wherein performing the image processing on at least one of the bayer subimage or the infrared subimage and the first image comprises:
acquiring a visible light depth image according to the bayer subimage and the first image.

7. The image processing method of claim 6, wherein the second-band light is emitted by an infrared light source comprising one of a structured light source or a time of flight (TOF) light source, and performing the image processing on at least one of the bayer subimage or the infrared subimage and the first image comprises:
fusing the visible light depth image and depth data of the infrared subimage to obtain a depth fused image.

8. The image processing method of claim 4, further comprising:
performing, responsive to a zooming operation of a user, image zooming based on the first image and the bayer subimage.

9. An image processing device, comprising:
a processor; and
a memory storing instructions executable by the processor;
wherein the processor is configured to:
acquire a first image generated by a first camera module and a second image generated by a second camera module, the second image comprising a bayer subimage generated by the second camera module by sensing first-band light and an infrared subimage generated by sensing second-band light; and
perform image processing on at least one of the bayer subimage or the infrared subimage and the first image.

10. The image processing device of claim 9, wherein the processor is further configured to:
fuse the infrared subimage and the first image to enhance the first image.

11. The image processing device of claim 9, wherein the processor is further configured to:
acquire a visible light depth image according to the bayer subimage and the first image.

12. The image processing device of claim 11, wherein, the second-band light is emitted by an infrared light source comprising one of a structured light source or a time of flight (TOF) light source, and the processor is further configured to:
fuse the visible light depth image and depth data of the infrared subimage to obtain a depth fused image.

13. The image processing device of claim 9, wherein the processor is further configured to:
responsive to a zooming operation of a user, perform image zooming based on the first image and the bayer subimage.

14. (canceled)

15. (canceled)
